(19) United States
(12) Patent Application Publication
(10) Pub. No.: US 2007/0214409 A1
(43) Pub. Date: Sep. 13, 2007

(54) IMAGE-FORMING APPARATUS AND CONTROL METHOD THEREOF

(75) Inventor: Junichi MIYATA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/682,009

(22) Filed: Mar. 5, 2007

(30) Foreign Application Priority Data
Mar. 8, 2006 (JP) 2006-063147

(51) Int. Cl. G06F 17/00; G06F 3/12; G06F 3/048

(52) U.S. Cl. 715/520; 715/517; 715/518; 715/765; 358/1.15

(57) ABSTRACT

An image-forming apparatus includes a database storing a layout template made up of containers, each representing a display area for a part of a user interface (UI). The user interface is configured by embedding display content in each container of the layout template in the database. On the occurrence of an event for changing arrangement of the user interface, the user interface is reconfigured by calculating arrangement of each container according to the size of the display content in one of the containers and embedding the display content in each container subjected to the calculation.

### BACKGROUND OF THE INVENTION

1. Field of the Invention

The present invention relates to image-forming apparatuses having functions of a printer, scanner, copier or the like, or multiplex functions thereof, and to methods for controlling the image-forming apparatuses.

2. Description of the Related Art

Image-forming apparatuses having multiplex functions including printer, image input, document filing, document transmission and reception, and image conversion functions are known. These image-forming apparatuses are also called multi-function peripherals. In recent multi-function peripherals, routine tasks involving a combination of various functions can be automated by additionally installing application modules.

Software in a multi-function peripheral is typically constructed on an execution environment implemented by a real-time OS that is highly dependent on the architecture for embedded systems, rather than by a general-purpose OS provided in personal computers and so on. To realize the aforementioned additional installation of application modules, a further execution environment (e.g., Java (R)) for embedded systems is constructed on the real-time OS (for example, see Japanese Patent Laid-Open No. 2003-330732). Such execution environments can make the application modules highly transportable.

A system configuration for centrally managing such application modules as above in a server has also been proposed (for example, see Japanese Patent Laid-Open No. 2002-152458). According to this system, a multi-function peripheral can download the latest application from the server.

If an application module is modified or a new application module is developed, a user interface (referred to as a UI hereinafter) may be customized.

A method for laying out a document page has also been proposed that realizes automatic layout adjustment such that the size of each partial area is optimized according to the amount of data to be inserted at different times (for example, see Japanese Patent Laid-Open No. 2005-216174). Specifically, the arrangement of images and text within a page is adjusted by making the distances (the lengths of links) between the partial areas (containers) flexibly changeable.

In a UI in which a number of parts such as operation buttons and image display areas are laid out, it is desired that a change in the size of one part should cause other parts to be dynamically rearranged to automatically maintain a smart layout. For example, in a UI having a preview area for a print image as one of its parts, it is desired that the preview area be resized according to the size of the image, and correspondingly the other parts be dynamically rearranged. This is also the case for a UI including display areas for information such as system management information and banner advertisements, in which the number of characters varies widely depending on the content.

However, current applications do not allow for dynamically changing the layout of a UI. With conventional techniques, changing the layout of a UI requires reinstalling the UI with another application designed for a different layout. This, however, cannot be called a “dynamic” change of the UI. Alternatively, an application with preset patterns for all conceivable UI layouts needs to be developed. However, development of such a complicated application will significantly increase the number of tasks for the developer. For example, it is empirically known that the usability in a UI of an application is improved if adjacent display components align at regular intervals. In addition, a rule is known that it is better if important functions are gathered at the center with their size increased as much as possible. However, even with these pieces of empirical knowledge, there may be the cases where the size of components constituting the UI cannot be uniquely determined or has a varying range. In such cases, conventional techniques need to update the application each time or to generate the application by taking the arrangement change in all cases of dynamic UI change into consideration.

In addition, in the conventional technique of updating the application on the server, all components constituting the UI, such as images, must be maintained in the server. Therefore, it also has a problem of the increased amount of communication between the server and the image processing apparatus.

### SUMMARY OF THE INVENTION

In one aspect of the present invention, An image-forming apparatus in which a user interface is configured on an operation unit in response to execution of an application, includes a storage unit adapted to store a layout template made up of containers, each representing a display area for a part of the user interface; a configuration unit adapted to configure the user interface by embedding display content in each container of the layout template; a calculation unit adapted to calculate arrangement of each container according to the size of the display content in one of the containers on the occurrence of an event for changing arrangement of the user interface; and a reconfiguration unit adapted to reconfigure the user interface by embedding the display content in each container subjected to the calculation by the calculation unit.

Further features of the present invention will become apparent from the following description of exemplary embodiments (with reference to the attached drawings).

### BRIEF DESCRIPTION OF THE DRAWINGS

FIG. 1 is a block diagram showing a configuration of an image-forming system according to an embodiment;

FIG. 2 is a block diagram showing a configuration of a core unit in the embodiment;

FIGS. 3 and 4 are diagrams of a software configuration of a control program in the embodiment;

FIG. 5 is a diagram showing an exemplary user interface for a web print application in the embodiment;

FIG. 6 is a diagram of a software configuration of a dynamic layout application in the embodiment;

FIG. 7 is a diagram showing an exemplary layout template in the embodiment;

FIG. 8 is a diagram showing an example in which a component has been inserted into the layout template in the embodiment;

FIG. 9 is a diagram showing exemplary coordinate information about the layout template in the embodiment;

FIG. 10 is a diagram showing an exemplary attribute table for the layout template in the embodiment;

FIG. 11 is a diagram showing exemplary components to be inserted into the layout template in the embodiment;

FIGS. 12A and 12B are diagrams showing exemplary results of arranging each container in the layout template in the embodiment;

FIG. 13 is a diagram showing an exemplary communication sequence in an application level between an information processing apparatus and an image-forming apparatus in the embodiment;

FIG. 14 is a flowchart showing operations of the web print application in the embodiment;

FIG. 15 is a flowchart showing operations of the dynamic layout application in the embodiment; and

FIG. 16 is a diagram showing an exemplary UI in which an announcement of network stop as a variable character string is displayed at the bottom of an application display area.

### DESCRIPTION OF THE EMBODIMENTS

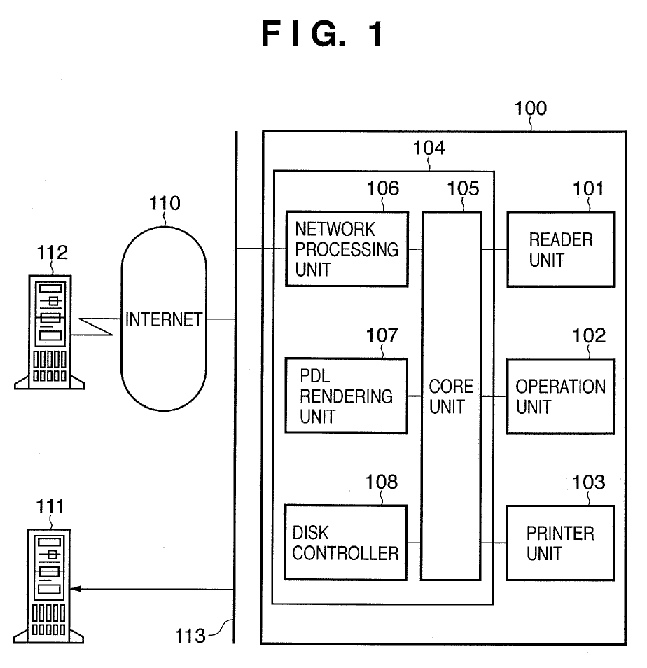

FIG. 1 is a block diagram showing a configuration of an image-forming system according to an embodiment.

As shown, an exemplary configuration of this image-forming system includes an image-forming apparatus 100, and a first and second information processing apparatuses 111 and 112. By way of example, the image-forming apparatus 100 and the first information processing apparatus 111 are provided at the same site and communicatively connected with each other over an intranet 113. Also by way of example, the second information processing apparatus 112 is provided at a site different from the site of the image-forming apparatus 100 and the first information processing apparatus 111. The second information processing apparatus 112 can communicate with the image-forming apparatus 100 over the intranet 113 and the Internet 110. The first and second information processing apparatuses 111 and 112 may be implemented by using general-purpose personal computers or workstations.

As shown, the image-forming apparatus 100 includes a reader unit 101, an operation unit 102, a printer unit 103, and a controller 104. The controller 104 includes a network processing unit 106, a PDL (page description language) rendering unit 107, a disk controller 108, and a core unit 105. The reader unit 101 reads a set document image and outputs resulting image data to the printer unit 103 via the core unit 105. The printer unit 103 performs document copy operations by recording the image on recording paper based on the image data from the reader unit 101.

As described-above, the first and second information processing apparatuses 111 and 112 may be implemented by general-purpose personal computers (PCs) or workstations (WSs). In the first and second information processing apparatuses 111 and 112, preinstalled software such as a printer driver may generate PDL data interpretable by the PDL rendering unit 107. The generated PDL data is transmitted to the image-forming apparatus 100 over the network 113. The image-forming apparatus 100 receives the PDL data in the network processing unit 106 and transfers it to the core unit 105. The PDL rendering unit 107 then renders the PDL data as image data that can be recorded by the printer unit 103. This image data may be printed in the printer unit 103 via the core unit 105.

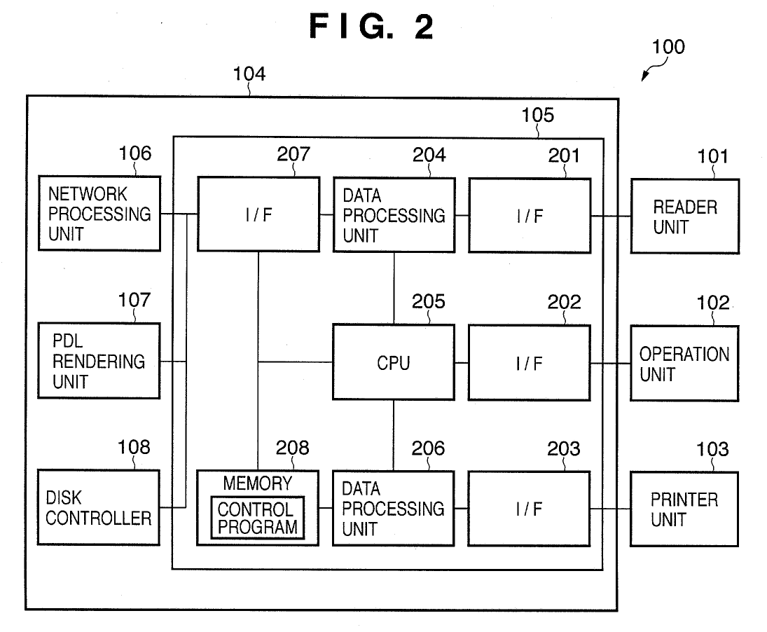

FIG. 2 is a block diagram of the image-forming apparatus 100, showing a configuration of the core unit 105 in greater detail. As shown, the core unit 105 includes interface units (I/Fs) 201, 202, 203, and 207, data processing units 204 and 206, a CPU 205, and a memory 208.

To specifically describe this configuration, the image data read in the reader unit 101 is transferred to the data processing unit 204 via the I/F 201. If the image is to be printed in the printer unit 103, the data processing unit 204 performs data processing such as rotation and scaling of the image. The image data subjected to the data processing is accumulated in the memory 208. The CPU 205 transfers the image data in the memory 208 to the printer unit 103 via the data processing unit 206 and the I/F 203 based on an internal control command generated by the operation unit 102 according to an operation performed on the operation unit 102. In this manner, the image data may be printed on the recording paper.

As described above, the PDL data generated in the first and second information processing apparatuses 111 and 112 may be input via the network processing unit 106. In that case, the CPU 205 transfers the input PDL data to the PDL rendering unit 107 via the I/F 207, SO that the PDL data is rendered as bitmap data. This bitmap data is accumulated in the memory 208 via the I/F 207. The bitmap data in the memory 208 may be transferred to the printer unit 103 via the data processing unit 206 and the I/F 203 to be printed there.

By way of example, the operation unit 102 is implemented using a liquid crystal panel. This liquid crystal panel has a touch-pad function, with which a key corresponding to a certain instruction for controlling the apparatus may be selected by a touch of a user's finger on the panel.

The CPU 205 performs control according to a control program stored in, for example, the memory 208, and according to control commands received from the operation unit 102 via the I/F 202. The memory 208 is also used as a work area for the CPU 205. Thus, mainly with the operation of the core unit 105, the image-forming apparatus 100 can perform multiplex functions such as reading and printing a document image, transmitting and receiving an image, storing an image, and inputting and outputting data from a computer.

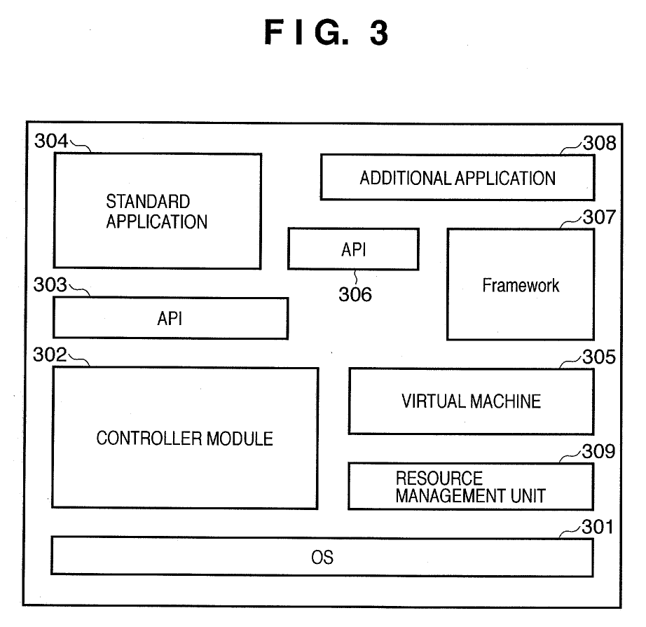

FIG. 3 is a diagram of a software configuration of the control program stored in the core unit 105 of the image-forming apparatus 100.

Reference numeral 301 denotes a first execution environment (OS) responsible for control over the entire image-forming apparatus. The OS 301 generally includes real-time OS modules capable of controlling various functions of the copier in real time, or libraries capable of issuing instructions to the CPU to critically control functions including optional devices and extension cards of the copier. The OS 301 further includes modules for providing interface commands to applications running above the OS.

Reference numeral 302 denotes a controller module operating on the OS 301. The controller module 302 consists of modules for controlling the reader unit 101, the printer unit 103, the PDL rendering unit 107, a disk controller 108, the network processing unit 106, and so on.

Reference numeral 303 denotes an application programming interface (referred to as an “API” hereinafter). The API 303 is a set of interfaces, each corresponding to one of a plurality of control commands for accessing the controller module 302 controlled by the OS 301. The API 303 has a function of providing processing for accessing the controller module 302 in response to an input of an instruction to control the apparatus from a standard application 304.

The standard application 304 is an application running on the OS 301 and implements copier functions by requesting the controller module 302 via the API 303 to perform various processing. This standard application 304 is an application having standard functions of a copier. An example of those functions may be a copy function, which is provided in a copier as a standard function, for reading a document with the reader unit 101 and outputting it onto a recording medium with the printer unit 103.

Reference numeral 305 denotes a virtual machine, which is a second execution environment for additionally installing and executing an application running on the image-forming apparatus. For example, the virtual machine 305 may be implemented by a Java (R) virtual machine.

Reference numeral 306 denotes an API by which an additional application 308 on the virtual machine 305 accesses the controller module 302 operating on the OS 301. In this embodiment, the API 306 also acts as an interface for calling the API 303. However, the API 306 may be identical with the API 303 or may be implemented with limited functions as a subset of the API 303.

Reference numeral 307 is a framework module having a function of comprehensively controlling the additional application 308 on the virtual machine 305.

Reference numeral 308 denotes the additional application installed and running on the virtual machine 305. The additional application 308 may use the API 306 to request the controller module 302 to perform various apparatus-depending processing. For example, through the API 306, the additional application 308 may request the reader unit 101 to read a document, or may obtain data from the first and second information processing apparatus 111 and 112 on the network 113 via the network processing unit 106.

Reference numeral 809 is a resource management unit managing resources used by the virtual machine 305, and operates on the real-time OS 301. When the virtual machine 305, the API 306, the framework 307, or the application 308 on the virtual machine 305 uses resources such as memory, the resource management unit 309 may restrict the use of more than a predetermined amount of resources.

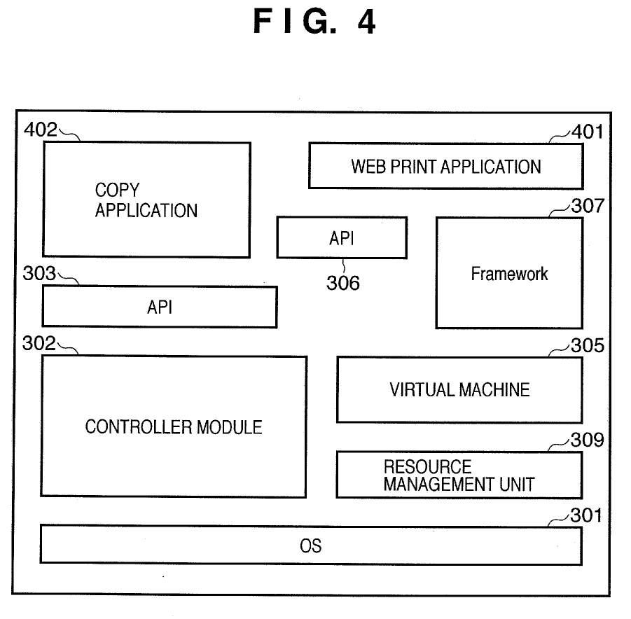

FIG. 4 shows a software configuration in which a copy application 402 and a web print application 401 have been installed as the standard application 304 and the additional application 308 in FIG. 3 respectively. The web print application 401 in this embodiment is an application for obtaining a particular document that resides on a certain web server and is interpretable by the PDL rendering unit 107, displaying a preview or document information for a user, and printing the document. While the example in FIG. 4 shows that a single application has been installed as each of the standard application 304 and additional application 308, two or more applications may be installed as each of them. In addition, while in this embodiment the web print application 401 runs as the additional application 308 on the virtual machine 305 as described above, it may run as the standard application 304 on the OS 301.

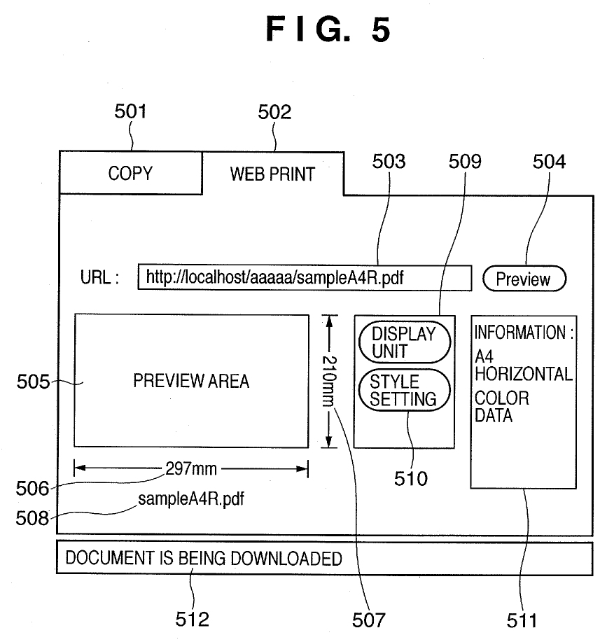

FIG. 5 is a diagram showing an exemplary UI screen displayed on the operation unit 102 when the copy application 402 and the web print application 401 shown in FIG. 4 have been installed. On this screen, a user can select the copy application 402 as the standard application 304 running on the OS 301, or the web print application 401 as the additional application 308 running on the virtual machine 305. As described above, this screen is implemented as a touch panel, on which the user may touch the inside of a frame of each displayed function to cause the function to be executed.

Reference numerals 501 and 502 denote tabs for selecting the applications. Pressing the COPY tab 501 causes a setting screen for the copy application 402 to be displayed, and pressing the WEB PRINT tab 502 causes a setting screen for the web print application 401 to be displayed. FIG. 5 illustrates the setting screen for the web print application 401.

Reference numeral 503 denotes a URL designation area for designating a URL that indicates the location of a document to be printed. The URL may be entered using a touch panel (not shown) or the like typically provided as standard equipment on a copier. Reference numeral 504 denotes a preview button. When the user presses the preview button 504 after entering the URL, the document designated in the URL designation area 503 is downloaded, and a preview of the document is displayed in a preview area 505.

Reference numeral 506 denotes a width display area displaying the width of the image displayed in the preview area 505 (in the illustrated example, 297 mm). Reference numeral 507 denotes a height display area displaying the height of the image displayed in the preview area 505 (in the illustrated example, 210 mm). Reference numeral 508 denotes an area displaying the file name of the document designated in the URL designation area 503.

Reference numeral 509 denotes a display unit switching button for switching the display unit for the preview image sizes displayed in the width display area 506 and the height display area 507 to, for example, millimeter or inch. Reference numeral 510 denotes a style setting button with which a UI (not shown) may be displayed to set the print style, such as two-sided printing and stapling at the time of printing. The user may be informed of the print style setting, for example by displaying in the preview area 505 an icon indicating that the document is stapled. Reference numeral 511 denotes an area containing document information such as the paper size and color information. In the example of FIG. 5, the information display area 511 indicates that the target document is color data of A4 horizontal paper.

Reference numeral 512 denotes an area indicating the current status of the selected application (in the example of FIG. 5, the web print application 401). In the illustrated example, it indicates that the document is being downloaded.

While the screen shown in FIG. 5 is displayed, if execution of operations is instructed by pressing a start key (not shown), the web print application 401 sequentially calls the API 306 for performing operations, such as starting processing and setting various parameters. Thus, apparatus control commands are conveyed to the controller module 302 and print operations are executed.

Now, the first information processing apparatus 111 in this embodiment will be described. The first information processing apparatus 111 functions not only as a host terminal that transmits the PDL data to the image-forming apparatus 100 but also as a processing server that performs dynamic UI arrangement processing for the image-forming apparatus 100. The first information processing apparatus 111 includes a dynamic layout application for implementing the dynamic UI arrangement processing. This dynamic layout application will be described below.

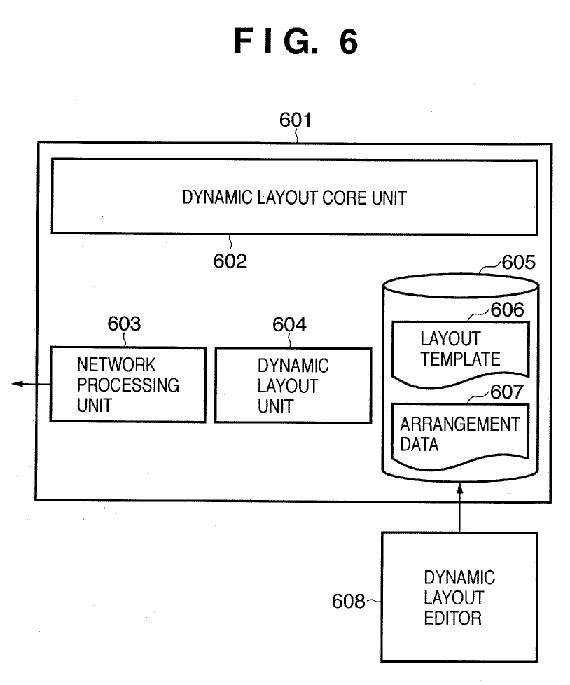

FIG. 6 is a diagram of a software configuration of a dynamic layout application 601 loaded onto the first information processing apparatus 111.

Reference numeral 602 denotes a dynamic layout core unit. The dynamic layout core unit 602 controls the entire applications operating on the first information processing apparatus 111, including a network processing unit 603, a dynamic layout unit 604, and a layout template 606 and arrangement data 607 on a database 605. The network processing unit 603 controls communications with the image-forming apparatus 100 to transmit and receive data and communication commands under instructions from the dynamic layout core unit 602. The database 605 maintains the layout template 606 that will be the outer frames for determining the UI arrangement of the additional application 308, and the arrangement-data 607 that stores coordinate information about, for example, images and text to be arranged in the layout template. Once the layout template 606 and the arrangement data 607 are determined, the dynamic layout unit 604 determines the UI arrangement according to rules described below.

Reference numeral 608 denotes a dynamic layout editor that updates the layout template 606. The dynamic layout editor may update the layout template with a tool like a text editor. Alternatively, the dynamic layout editor may be configured to allow the user to edit using a graphical user interface (GUI).

Now, the relationship between the aforementioned layout template 606 and arrangement data 607 will be described.

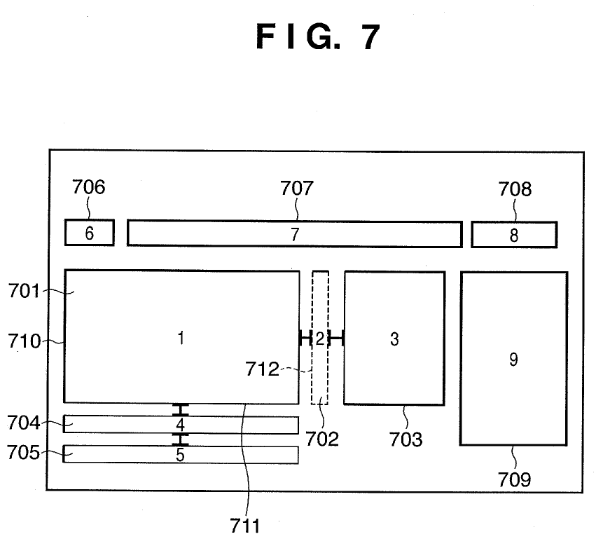

The layout template 606 is template information defining a UI arrangement pattern. FIG. 7 shows an example of the layout template 606 corresponding to the UI arrangement shown in FIG. 5.

In FIG. 7, each of reference numerals 701 to 709 denotes a container representing a display area for a part of the UI components. The relationship between the containers in FIG. 7 and the areas in FIG. 5 is as follows.

The container 701 corresponds to the preview area 505.

The container 702 corresponds to the height display area 507.

The container 703 corresponds to the area surrounding the display unit button 509 and the style setting button 510.

The container 704 corresponds to the width display area 506.

The container 705 corresponds to the file name display area 508.

The container 706 corresponds to the area for containing the characters “URL:” displayed at the left of the URL designation area 503.

The container 707 corresponds to the URL designation area 503.

The container 708 corresponds to the preview button 504.

The container 709 corresponds to the information display area 511.

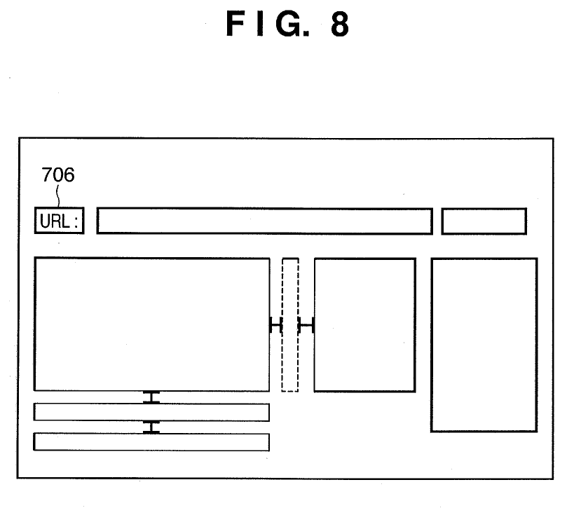

When the size information is determined about pieces of object data such as the text and images, which are the display content to be eventually inserted by the image-forming apparatus, the dynamic layout unit 604 determines the arrangement of each piece of object data. For example, FIG. 8 shows that the character string “URL:” has been entered in the container 706 and the object data arrangement of the container 706 has been determined.

In this manner, the UI of the web print application 401 is configured by inserting the object data such as text and images into all containers in the layout template.

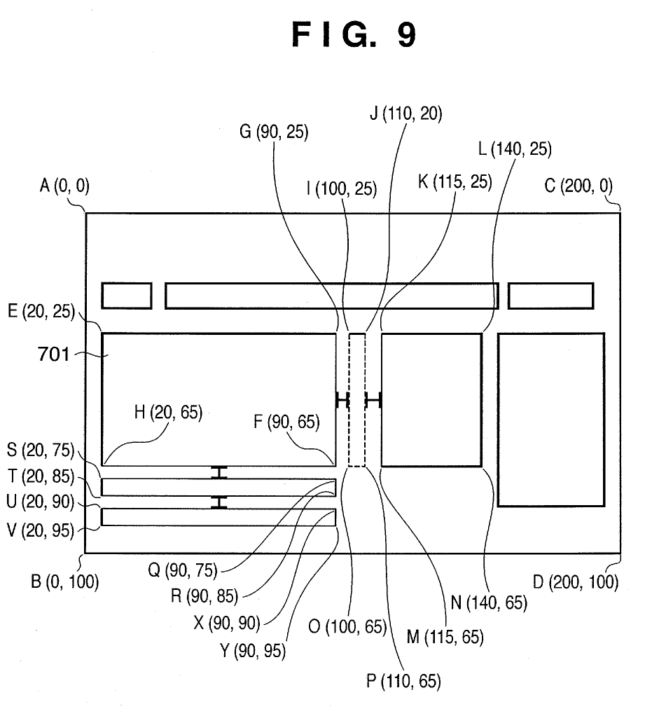

The arrangement data 607 stores information about coordinates where each piece of object data is placed. FIG. 9 shows an example of typical container coordinate information.

In FIG. 9, a coordinate point A indicates the origin coordinates (0, 0) of the UI. A coordinate point B indicates the maximum coordinates in the vertical (Y) direction from the origin, and a coordinate point C indicates the maximum coordinates in the horizontal (X) direction from the coordinate point A. The example of FIG. 9 shows that the UI is designed in a rectangle with a width of 200 and a height of 100, as indicated by a coordinate point D. It is also indicated that the container 701 is designed in a rectangle area defined by diagonally opposed coordinate points E (20, 25) and F (90, 65).

Furthermore, the layout template has the following attributes for each container.

(a) whether each side of the container has a fixed length or variable length

(b) if the side has a variable length, its effective range (constraints)

(c) priority in calculating the position of the containers

Each of the attributes will be described below.

In FIG. 7, sides represented as bold lines like the side 710 indicate that they are fixed sides with regard to the above attribute (a). On the other hand, sides represented as fine lines like the side 711 indicate that they are variable lines with regard to the above attribute (a). A fixed side will never be changed in its position hereinafter even when the layout arrangement is updated. In contrast, a variable-length side can be changed in its position when the layout arrangement is updated.

In FIG. 7, portions sandwiched between two opposing variable-length sides capable of layout change are labeled with an H-shaped connecting icon as indicated by reference numeral 712. This icon indicates a portion where the layout can be updated between two containers.

Also in FIG. 7, the number provided at the center of each container rectangle indicates the priority among the containers, which will be described below. This priority indicates the priority of the containers in calculation of the coordinate arrangement when the layout arrangement is updated, and a smaller number has higher priority in calculation of the coordinate arrangement.

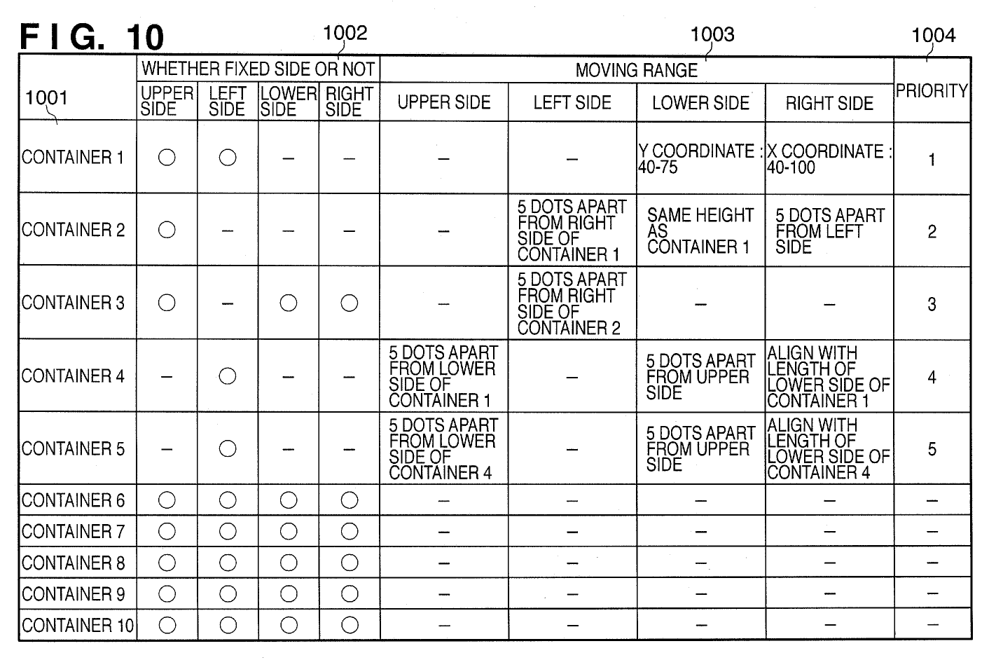

The layout template has constraints as shown in FIG. 10.

Reference numeral 1001 indicates container IDs for identifying the containers. Reference numeral 1002 indicates whether each side of the containers identified by the container IDs is a fixed side (corresponding to the above-described attribute (a)). For example, as shown, a setting value is stored for each of the upper, left, lower, and right sides, and ◯ indicates that the corresponding side is a fixed side. Reference numeral 1003 indicates what constraint is imposed on each side indicated by the container IDs, and the constraint is stored for each of the upper, left, lower, and right sides. Each constraint 1003 indicates possible values for a variable-length side of the containers, that is, a constraint defining a limitation for the variable part (corresponding to the above-described attribute (b)). Reference numeral 1004 indicates the aforementioned priority in determining the arrangement of the containers identified by the container IDs (corresponding to the above-described attribute (c)). A smaller number has higher priority in calculation.

In FIG. 10, it is indicated that the container 1 has its upper and left sides fixed, and its lower and right sides variable. It is also indicated that the Y coordinate on the lower side of the container 1 falls within the range of 40 to 75, and the X coordinate on the right side falls within the range of 40 to 100. Furthermore, the priority of the container 1 is set to 1.

Similarly, it is indicated that the container 2 only has its upper side fixed, and the left side is 5 dots away from the right side of the container 1. It is also indicated that the lower side aligns with the height of the container 1, and the right side is 5 dots away from the left side of the container 2. The priority is 2.

Similarly, it is indicated that the container 3 has its upper, lower, and right sides fixed, and the left side is 5 dots away from the right side of the container 2. The priority is 3.

Similarly, it is indicated that the container 4 has its left side fixed, and the Y coordinate on the upper side is 5 dots away from the lower side of the container 1. It is also indicated that the lower side is 5 dots away from the upper side of the container 4, and the right side aligns with the length of the lower side of the container 1. The priority is 4.

Similarly, it is indicated that the container 5 has its left side fixed, and the upper side is 5 dots away from the lower side of the container 4. It is also indicated that the lower side is 5 dots away from the upper side of the container 5, and the right side aligns with the length of the lower side of the container 4. The priority is 5.

Regardless of the illustrated example, various constraints may be imposed, such as setting area limits for all containers.

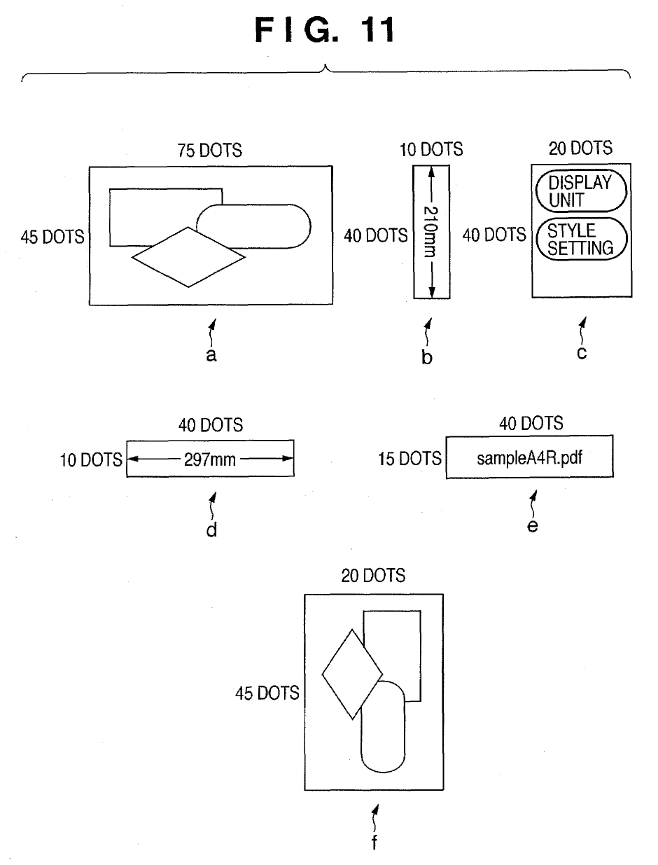

Next, a specific example of calculating the container arrangement will be described using FIG. 11.

It is assumed here that the following images are to be inserted into the containers in the layout template respectively.

container 1: an image with a width of 75 dots and a height of 45 dots shown in FIG. 11(a)

container 2: an image with a width of 10 dots and a height of 40 dots shown in FIG. 11(b)

container 3: an image with a width of 20 dots and a height of 40 dots shown in FIG. 11(c)

container 4: an image with a width of 40 dots and a height of 10 dots shown in FIG. 11(d)

container 5: an image with a width of 40 dots and a height of 15 dots shown in FIG. 11(e)

The arrangement is calculated as follows based on the constraints and the priority.

First, the arrangement of the container 1 with the highest priority is calculated.

Referring to the attribute table in FIG. 10, it can be seen that the upper and lower sides of the container 1 are fixed sides, so that the coordinate point E (20, 25) shown in FIG. 9 is the upper-left origin. Here, the width of the image in FIG. 11(a) is 75 dots, whereas the width in the layout template is 70 dots from the coordinate point E (20, 25) to the coordinate point G (90, 25). Therefore, the X coordinate on the right side of the container 1 is extended by 75−70=5 dots and moved from 90 of the layout template to 95. According to the constraint, the moving range of the X coordinate on the right side of the container 1 is 40 to 100, and 95 falls within this range. Therefore, the X coordinate on the right side of the container 1 is determined as 95.

As to the Y coordinate of the container 1, the height of the image in FIG. 11(a) is 45 dots, whereas the height in the layout template 40 from the coordinate point E (20, 25) to the coordinate point H (20, 65). Therefore, the Y coordinate on the lower side of the container 1 is moved from 65 to 70. According to the constraint, the moving range of the Y coordinate on the lower side of the container 1 is 40 to 75, and 70 falls within this range. Therefore, the Y coordinate on the lower side of the container 1 is determined as 70.

Next, the arrangement of the container 2 with the second priority is calculated.

According to the constraint on the container 2, the left side of the container 2 should be 5 dots away from the right side of the container 1. Therefore, the starting X coordinate position on the left side of the container 2 will be 100, which is obtained by adding 5 dots to the X coordinate on the right side of the container 1. Furthermore, since the width of the image in FIG. 11(b) to be laid out in the container 2 is 10 dots, the X coordinate on the right side of the container 2 is determined as 110.

The Y coordinate on the lower side of the container 2 is determined as 70 because it should be the same as the Y coordinate of the container 1 according to the constraint. Here, the height of the image is 40 dots, whereas the height of the container 2 becomes 45 dots. Therefore, the Y coordinate of the image in FIG. 11(b) will be extended and displayed to align with the height of the container 1.

Next, the arrangement of the container 3 with the third priority is calculated.

According to the constraint on the container 3, the left side of the container 3 should be 5 dots away from the right side of the container 2. Therefore, the X coordinate position on the left side of the container 3 will be 115, which is obtained by adding 5 dots to the right side of the container 2. The width of the image in FIG. 11(c) to be laid out in the container 3 is 20 dots, whereas the right side of the container 3 is a fixed side and its X coordinate is fixed to 140. As a result, the X coordinate on the right side of the container 3 is determined as 140. That is, the width of the container 3 becomes 140−115=25 dots, so that the width of the image in FIG. 11(c) is extended from 20 dots to 25 dots. The lower side is a fixed side and its Y coordinate becomes 65−25=40 dots in the template, while the height of the image in FIG. 11(c) is also 40 dots. Therefore, no change is made in the size.

Next, the arrangement of the container 4 with the fourth priority is calculated.

According to the constraint on the container 4, the upper side of the container 4 should be 5 dots away from the lower side of the container 1. Therefore, the Y coordinate position on the upper side will be 75, which is obtained by adding 5 dots to the Y coordinate on the lower side of the container 1. Since the lower side of the container 4 is 10 dots away from the upper side, the Y coordinate is determined as 85. The right side of the container 4 will be at 75 dots because it should align with the length of the lower side of the container 1. That is, the image in FIG. 11(d) to be laid out in the container 4, which has a width of 40 dots, is extended to 75 dots in the horizontal direction.

Finally, the arrangement of the container 5 with the fifth priority is calculated.

According to the constraint on the container 5, the upper side of the container 5 should be 5 dots away from the lower side of the container 4. Therefore, the Y coordinate position on the upper side will be 90, which is obtained by adding 5 dots to the Y coordinate on the lower side of the container 4. Since the lower side of the container 5 is 5 dots away from the upper side, it is determined as 95. The right side of the container 5 will be at 75 dots because it should be aligned with the length of the lower side of the container 1. That is, the image in FIG. 11(e) to be laid out in the container 5, which has a width of 40 dots, is extended to 75 dots.

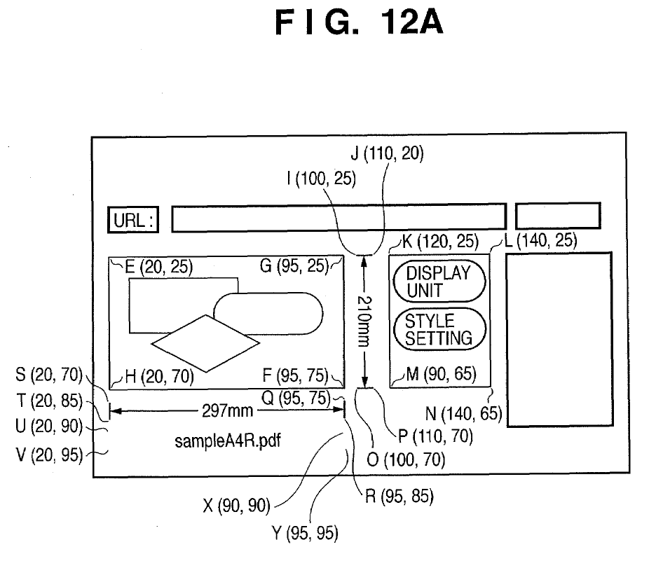

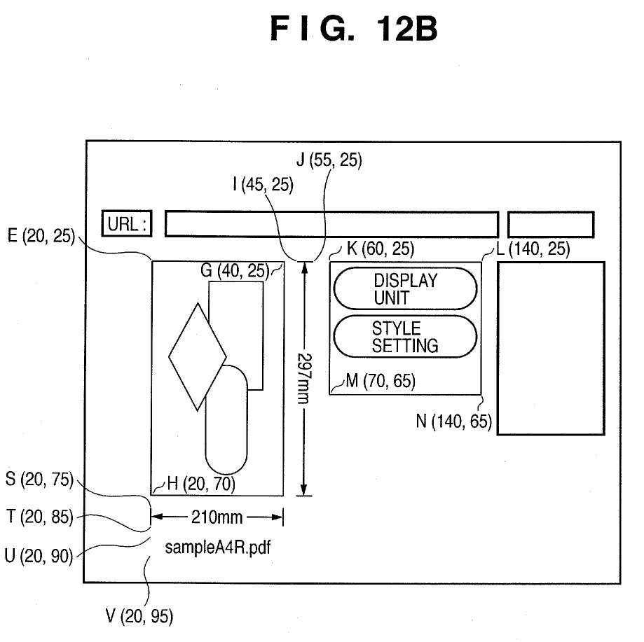

As a result, if the images shown in FIG. 11 are placed in the containers based on the template in FIG. 9 and the constraints in FIG. 10, the arrangement is determined as shown in FIG. 12A.

In the illustrated example of this embodiment, the arrangement ends in success. If, for example, the last container with the lowest priority has an effective range resulting in failure of the arrangement by the above-described calculation, the processing may be regarded as an error and terminated.

Now, consider the case where the image in FIG. 11(a) to be arranged in the container 1 is replaced with an image in FIG. 11(f) with a height of 45 dots and a width of 20 dots. The arrangement in this case is calculated as follows.

First, the arrangement of the container 1 with the highest priority is calculated.

According to the constraints on the container 1, the upper and lower sides are fixed sides, so that the coordinate point E (20, 25) shown in FIG. 9 is the upper-left origin. Here, the width of the image in FIG. 11(f) is 20 dots, whereas the width in the layout template is 70 dots from the coordinate point E (20, 25) to the coordinate point G (90, 25). Therefore, the X coordinate on the right side of the container 1 is reduced by 70−20=50 dots and moved from 90 of the layout template to 40. According to the constraint, the moving range of the X coordinate on the right side of the container 1 is 40 to 100, and 40 falls within this range. Therefore, the X coordinate on the right side of the container I is determined as 40.

As to the Y coordinate of the container 1, the height of the image in FIG. 11(f) is 45 dots, whereas the height in the layout template is 40 from the coordinate point E (20, 25) to the coordinate point H (20, 65). Therefore, the Y coordinate on the lower side of the container 1 is moved from 65 to 70. According to the constraint, the moving range of the Y coordinate on the lower side of the container 1 is 40 to 75, and 70 falls within this range. Therefore, the Y coordinate on the lower side of the container 1 is determined as 70.

Next, the arrangement of the container 2 with the second priority is calculated.

According to the constraints on the container 2, the left side of the container 2 should be 5 dots away from the right side of the container 1. Therefore, the starting X coordinate position on the left side of the container 2 will be 45, which is obtained by adding 5 dots to the X coordinate on the right side of the container 1. Furthermore, since the width of the image in FIG. 11(b) to be laid out in the container 2 is 10 dots, the X coordinate on the right side of the container 2 is determined as 55.

The Y coordinate on the lower side of the container 2 is determined as 70 because it should be the same as the Y coordinate of the container 1 according to the constraint. Here, the height of the image is 40 dots, whereas the height of the container 2 becomes 45 dots. Therefore, the image in FIG. 11(b) will be extended in the Y direction and displayed.

Next, the arrangement of the container 3 with the third priority is calculated.

According to the constraint on the container 3, the left side of the container 3 should be 5 dots away from the right side of the container 2. Therefore, the X coordinate position on the left side of the container 3 will be 65, which is obtained by adding 5 dots to the right side of the container 2. The width of the image in FIG. 11(c) to be laid out in the container 3 is 20 dots, whereas the right side of the container 3 is a fixed side and its X coordinate is fixed to 140. As a result, the X coordinate on the right side of the container 3 is determined as 140. Since the lower side is a fixed side, its Y coordinate will not be changed.

Next, the arrangement of the container 4 with the fourth priority is calculated.

According to the constraint on the container 4, the upper side of the container 4 should be 5 dots away from the lower side of the container 1. Therefore, the Y coordinate position on the upper side will be 75, which is obtained by adding 5 dots to the Y coordinate on the lower side of the container 1. Since the lower side of the container 4 is 10 dots away from the upper side, its Y coordinate is determined as 85. The right side of the container 4 will be at 75 dots because it should be aligned with the length of the lower side of the container 1. That is, the image in FIG. 11(d) to be laid out in the container 4, which has a width of 40 dots, is extended to 75 dots.

Finally, the arrangement of the container 5 with the fifth priority is calculated.

According to the constraint on the container 5, the upper side of the container 5 should be 5 dots away from the lower side of the container 4. Therefore, the Y coordinate position on the upper side will be 85, which is obtained by adding 5 dots to the Y coordinate on the lower side of the container 4. Since the lower side of the container 5 is 5 dot away from the upper side, it is determined as 90. The right side of the container 5 will be 75 dots because it should be aligned with the length of the lower side of the container 1. That is, the image in FIG. 11(e) to be laid out in the container 5, which has a width of 40 dots, is extended to 75 dots.

As a result, if the images shown in FIG. 11 are placed in the containers based on the template in FIG. 9 and the constraints in FIG. 10, the arrangement is determined as shown in FIG. 12B.

Now, cooperative processing by the additional application 308 on the image-forming apparatus 100 and the dynamic layout application 601 on the information processing apparatus 111 will be described.

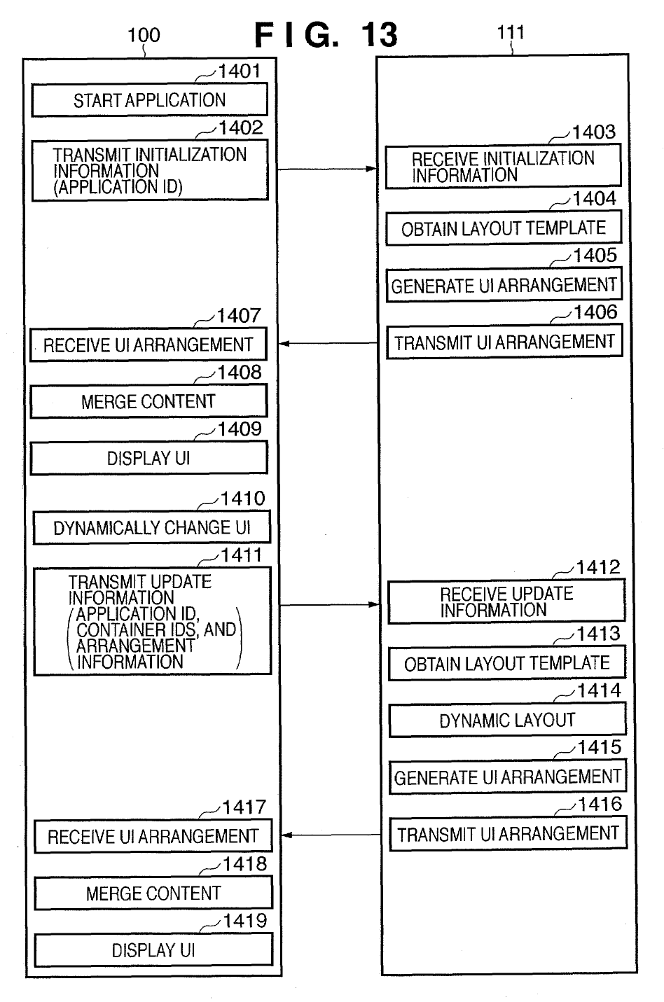

FIG. 13 is a diagram showing an exemplary communication sequence between the dynamic layout application 601 running on the first information processing apparatus 111 and the additional application 308 running on the image-forming apparatus 100. Upon startup of the additional application 308 on the image-forming apparatus 100 (step 1401), the additional application 308 requests the dynamic layout application 601 on the information processing apparatus 111 to generate the UI arrangement. At this point, the additional application 308 transmits an application ID specifying the additional application 308 as initialization information (step 1402).

In step 1403, the dynamic layout application 601 receives the initialization information and obtains a preset layout template for the application based on the application ID (step 1404). For example, this layout template may be similar to the one shown in FIG. 9.

The dynamic layout application 601 generates UI arrangement information (step 1405). In this initialization, the dynamic layout application 601 transmits the coordinate information as shown in FIG. 9 to the additional application 308 (step 1406).

The additional application receives this coordinate information (step 1407). The additional application then embeds its own display content (object data) as shown in FIG. 11 in areas specified by the received coordinate information (step 1408) and provides screen display in step 1409.

When dynamic UI change is performed (step 1410), the additional application 308 transmits the IDs of changed containers and the size information about changed content to the dynamic layout application 601 (step 1411). The dynamic layout application 601, having received the update information in step 1412, identifies the layout template based on the application ID and dynamically changes the overall areas based on the area information in the above-described manner (step 1414). Thus, the dynamic layout application 601 generates the UI arrangement (step 1415) and transmits the coordinate information to the additional application 308 (step 1416).

The additional application 308 receives the UI arrangement in step 1417 and arranges its own display content according to the received coordinate information (step 1418). It then updates the UI (step 1419).

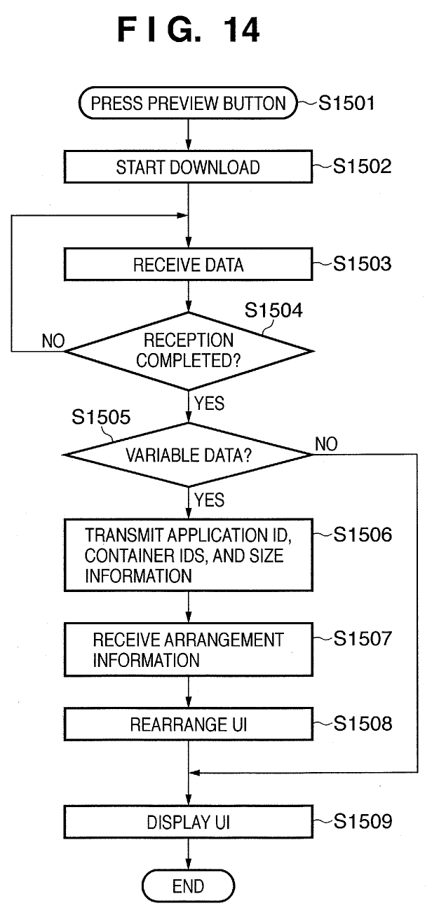

FIG. 14 is a flowchart showing operations of the web print application 401 corresponding to the steps from 1410 onward in the communication sequence in FIG. 13.

The flow in FIG. 14 is started upon occurrence of a predetermined event for changing the UI arrangement. Since this example illustrates operations of the web print application 401, a press on the preview button 504 by a user is the event for changing the UI arrangement (step S1501). When this event occurs, download of a document at a URL designated in the URL designation area 503 is started (step S1502). The web print application 401 receives document data at the URL from a relevant web server (step S1503). It is determined in step S1504 whether the reception has been completed. If not, the process returns to step S1503 to continue the reception of the document.

Once the document has been received, the web print application determines the size of the received document. It then determines whether the data is variable data to be dynamically changed from that already displayed in the preview area 505 (step S1505). If it is determined that the data is variable data, then in step S1506, the application ID, container IDs, and content size information are transmitted to the dynamic layout application on the first information processing apparatus 111 (step S1506). In step S1507, the UI arrangement information is received from the dynamic layout application. In step S1508, the UT is rearranged according to the arrangement information received in step S1507, and displayed on the display unit 102 (step S1509).

In this manner, the layout can be dynamically changed if a downloaded document is variable-length data determined at the point of download, for example the data in FIGS. 11(a) and 11(f).

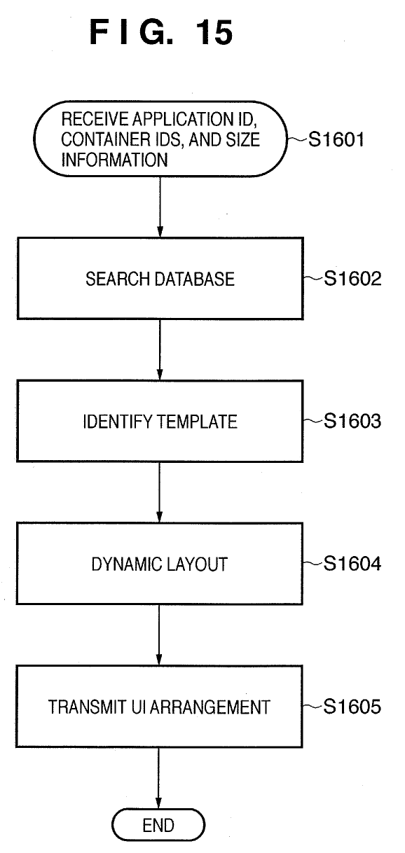

FIG. 15 is a flowchart showing operations of the dynamic layout application 601 corresponding to the operations of the web print application 401 in FIG. 14.

After the application ID, container IDs, and content size information are transmitted from the web print application in step S1506 of FIG. 14, the dynamic layout application 601 receives these items (step S1601).

The dynamic layout application 601 searches the database 605 based on these received information items (step S1602) and identifies the layout template 606 corresponding to the application ID (step S1603).

The dynamic layout processing is performed in the dynamic layout unit 604 in the above-described manner based on the container IDs identifying containers and the size information about these containers subjected to the dynamic change (step S1604). The resulting coordinate information is transmitted to the web print application 401 (step S1605).

Thus, for the web print application 401 in this embodiment, if the preview area 505 for a document is changed according to the size of the document, the other containers in the UI are also optimally rearranged.

In the above-described embodiment, an image to be placed in the container 701 (container 1) shown in FIG. 9 is variable-length content like images in FIGS. 11(a) and 11(f), and the optimal UI arrangement designed in advance in the template by a designer is realized.

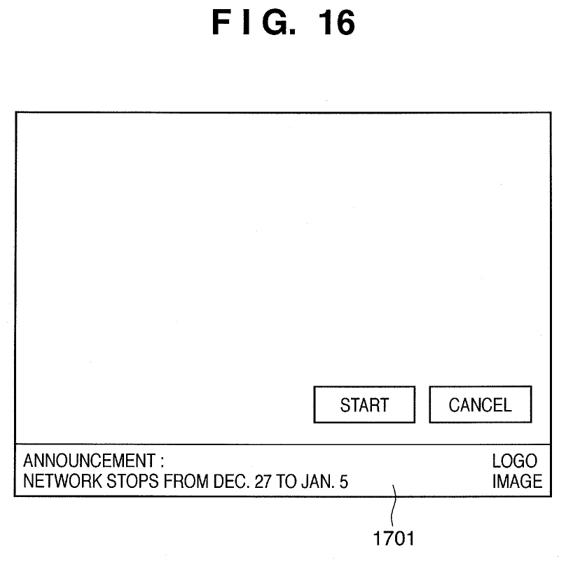

The above-described dynamic UI arrangement is also applicable to an application displaying a variable character string, such as an application in which a displayed character string is updated daily. For example, a possible daily updated character string may be management information in company use. As an example of such management information, FIG. 16 shows an exemplary UI in which an announcement of network stop is displayed in a display bar 1701 at the bottom of an application display area. This type of management information varies in the number of characters depending on the content, and sometimes it may not fit into one line and have to be displayed in several lines. Therefore, in such an application, it is preferable to dynamically rearrange the layout according to the number of characters or lines of the management information. This can be realized by giving high priority to a container for the display bar 1701. However, the container for the display bar 1701 may be given lower priority than other containers depending on a layout policy, such as when the arrangement of buttons is given higher priority. In that case, although the size of the display bar 1701 is not significantly changed, the displayed character size is preferably changed according to the number of displayed characters instead.

Besides the above-described preview screen and management information, the foregoing dynamic UI arrangement may be performed for a copier provided in places such as a convenience store according to the display size of information such as announcements and banner advertisements. This displayed information is temporarily displayed information for which display conditions and the display period may be set for that particular apparatus.

Furthermore, the UI may be dynamically arranged depending on the place where the apparatus resides, such as by enlarging displayed buttons but narrowing the space between containers in a welfare institution.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automaticaily-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-063147, filed Mar. 8, 2006, which is hereby incorporated by reference herein in its entirety.

What is claimed is:

1. An image-forming apparatus in which a user interface is configured on an operation unit in response to execution of an application, comprising:
a storage unit adapted to store a layout template made up of containers, each representing a display area for a part of the user interface;
a configuration unit adapted to configure the user interface by embedding display content in each container of the layout template;
a calculation unit adapted to calculate arrangement of each container according to the size of the display content in one of the containers on the occurrence of an event for changing arrangement of the user interface; and
a reconfiguration unit adapted to reconfigure the user interface by embedding the display content in each container subjected to the calculation by said calculation unit.

2. The image-forming apparatus according to claim 1, wherein a moving range is set for each side of each container in the layout template, and said calculation unit calculates the arrangement of each container within the moving range for the container.

3. The image-forming apparatus according to claim 2, wherein the order of priority in calculation by said calculation unit is further given to each container in the layout template, and the one of the containers is set to first priority.

4. The image-forming apparatus according to claim 1, wherein an image of a variable size is placed in the one of the containers.

5. The image-forming apparatus according to claim 4, wherein the image is a preview image of a document.

6. The image-forming apparatus according to claim 1, wherein a character string to be displayed with a variable number of characters or lines is placed in the one of the containers.

7. A method for controlling an image-forming apparatus in which a user interface is configured on an operation unit in response to execution of an application, comprising the steps of:
configuring the user interface by embedding display content in each container of a layout template made up of containers, each representing a display area for a part of the user interface;
calculating arrangement of each container according to the size of the display content in one of the containers on the occurrence of an event for changing arrangement of the user interface; and
reconfiguring the user interface by embedding the display content in each container subjected to the calculation.

8. A computer program for controlling an image-forming apparatus including a computer executing the program, and an operation unit on which a user interface is configured, the program comprising code for performing the following steps:
configuring the user interface by embedding display content in each container of a layout template, the layout template being a pattern of arrangement of the user interface made up of containers, each representing a display area for a part of the user interface;
calculating arrangement of each container according to the size of the display content in one of the containers on the occurrence of an event for changing arrangement of the user interface; and
reconfiguring the user interface by embedding the display content in each container subjected to the calculation.

9. An image-forming system comprising an image-forming apparatus in which a user interface is configured on an operation unit in response to execution of an application, and an information processing apparatus communicatively connected with said image-forming apparatus,
said information processing apparatus comprising:
a storage unit adapted to store a layout template made up of containers, each representing a display area for a part of the user interface; and
a first transmission unit adapted to transmit coordinate information about each container in the layout template to said image-forming apparatus, and
said image-forming apparatus comprising:
a configuration unit adapted to configure the user interface by embedding display content in areas specified by the coordinate information received from said information processing apparatus; and
a second transmitting unit adapted to transmit, to said information processing apparatus, identification information about containers to be changed in the configured user interface, and size information about the display content in the containers to be changed, and
said information processing apparatus further comprising:
a changing unit adapted to change arrangement of each container according to the identification information and the size information received from said image-forming apparatus; and
a third transmission unit adapted to transmit arrangement information about each changed containers to said image-forming apparatus, and
said image-forming apparatus further comprising
a reconfiguration unit adapted to reconfigure the user interface by embedding the display content according to the arrangement information about each containers received from said information processing apparatus.
